(19) United States
(12) Patent Application Publication
(10) Pub. No.: US 2026/0277041 A1
(43) Pub. Date: Sep. 17, 2026

(54) DRIVING METHOD FOR ELECTRONIC DEVICE

(71) Applicant: InnoLux Corporation, Miao-Li County (TW)

(72) Inventors: Shih-Yan FANG, Miao-Li County (TW); Ming-Chi GUO, Miao-Li County (TW); Po-Yang CHEN, Miao-Li County (TW); I-An YAO, Miao-Li County (TW)

(21) Appl. No.: 19/463,522

(22) Filed: Jan. 29, 2026

(30) Foreign Application Priority Data
Feb. 24, 2025 (CN) 202510203166.1

(51) Int. Cl. G02F 1/133

(52) U.S. Cl. CPC G02F 1/13306

(57) ABSTRACT

A driving method for an electronic device includes: providing a panel, a first driving element and a control element, wherein the first driving element is electrically connected between the panel and the control element; when the control element determines that the panel is performed with a partial resetting, in the reset phase of the panel, the control element providing a first logic signal to the first driving element and causing a plurality of first pixels electrically connected to the first driving element to be set to a high impedance mode, wherein the plurality of first pixels are pixels in the panel that do not need to be reset.

### CROSS-REFERENCE TO RELATED APPLICATIONS

This application claims the benefits of the Chinese Patent Application Serial Number 202510203166.1, filed on Feb. 24, 2025, the subject matter of which is incorporated herein by reference.

### BACKGROUND

### Field of the Disclosure

The present disclosure relates to a driving method for an electronic device and, more particularly, to a driving method for an electronic device that can reduce power consumption.

### Description of Related Art

In a typical passive-matrix panel, a partial resetting of the cholesteric liquid crystal is performed by applying a voltage waveform to the first electrodes of the portion to be reset, while simultaneously applying another voltage waveform to all of the second electrodes (overlapping the first electrodes). This allows the cholesteric liquid crystal in the middle portion between the first electrodes and the second electrodes to obtain a voltage difference sufficient to transition to a homeotropic state, thereby resetting the cholesteric liquid crystal in the middle portion and achieving the effect of resetting the image.

However, during this partial resetting process, a voltage waveform must additionally be applied to the common electrodes that need to be reset, and another voltage waveform must still be applied to the common electrodes that do not need to be reset. This makes it impossible to reduce the power consumption required for the partial resetting and thus cannot meet the actual requirements.

Therefore, it is desired to provide an improved driving method for an electronic device to alleviate and/or obviate the aforementioned problems.

### SUMMARY

The present disclosure provides a driving method for an electronic device, which includes: providing a panel, a first driving element, and a control element, wherein the first driving element is electrically connected between the panel and the control element; when the control element determines that the panel requires a partial resetting, in a reset phase of the panel, the control element providing a first logic signal to the first driving element, so that a plurality of first pixels electrically connected to the first driving element are set to a high-impedance mode, wherein the plurality of first pixels are pixels in the panel that do not require resetting.

Other novel features of the disclosure will become more apparent from the following detailed description when taken in conjunction with the accompanying drawings.

### BRIEF DESCRIPTION OF DRAWINGS

FIG. 1A shows a driving method for an electronic device for performing a partial resetting on a panel according to an embodiment of the present disclosure;

FIG. 1B is a schematic structural diagram of the panel;

FIG. 2 is a schematic diagram illustrating a partial resetting performed on the panel;

FIG. 3 shows a driving method for an electronic device for performing a partial resetting on a panel according to another embodiment of the present disclosure;

FIG. 4 shows a driving method for an electronic device for performing a partial resetting on a panel according to another embodiment of the present disclosure;

FIG. 5 shows a driving method for an electronic device for performing a partial resetting on a panel according to another embodiment of the present disclosure;

FIG. 6 is a flowchart illustrating a driving method for an electronic device of the present disclosure;

FIG. 7 is a cross-sectional structural diagram of an electronic device of the present disclosure;

FIG. 8 is a circuit block diagram of an electronic device of the present disclosure for performing the driving method of the embodiment shown in FIG. 1A or FIG. 4;

FIG. 9 is another circuit block diagram of an electronic device of the present disclosure for performing the driving method of the embodiment shown in FIG. 3 or FIG. 5;

FIG. 10 shows an embodiment for demonstrating the use of the driving method for an electronic device of the present disclosure for performing a partial resetting on a panel; and

FIG. 11 shows another embodiment for demonstrating the use of the driving method for an electronic device of the present disclosure for performing a partial resetting on a panel.

### DETAILED DESCRIPTION OF EMBODIMENT

Different embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims, such as “electrically connect” and “couple”, are intended that an element may not only directly electrically connect to other element, but also indirectly electrically connect to other element.

In addition, in the specification and claims, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “ranging from the first value to the second value” and “range between the first value and the second value” indicate that the range includes the first value, the second value, and other values between the first value and the second value.

Unless otherwise defined, all terms (including technical and scientific terms) used here have the same meanings as commonly understood by those skilled in the art of the present disclosure. It is understandable that these terms, such as those defined in commonly used dictionaries, should be interpreted as having a meaning consistent with the relevant technology and the background or context of the present disclosure, rather than in an idealized or excessively formal interpretation.

In addition, the electronic device of the present disclosure may include a display device, a tiled device, a touch display, a curved display, or a free shape display, but not limited thereto. The electronic device may, for example, include a liquid crystal, a light-emitting diode, fluorescence, phosphorescence, other suitable display media, or a combination thereof, but not limited thereto. The display device may be a non-self-luminous display device or a self-luminous display device. The electronic components may include passive components and active components, such as capacitors, resistors, inductors, diodes, transistors, etc. The diode may include a light-emitting diode (LED) or a photodiode. The light-emitting diode may, for example, include an organic light-emitting diode (OLED), a sub-millimeter light-emitting diode (mini LED), a micro LED, or a quantum dot light-emitting diode (quantum dot LED), but not limited thereto. The tiled device may be, for example, a display tiled device or an antenna tiled device, but not limited thereto. In addition, the electronic device may be a bendable or flexible electronic device. It should be noted that the electronic device may be any of the aforementioned arrangements and combinations, but not limited thereto. In addition, the appearance of the electronic device may be rectangular, circular, polygonal, a shape with curved edges, or other suitable shapes. The electronic device may have peripheral systems such as a drive system, a control system, a light source system, a shelf system, etc. to support the display device or the tiled device. For the convenience of explanation, in the following description, the electronic device will be exemplified by a display device, but the present application is not limited thereto.

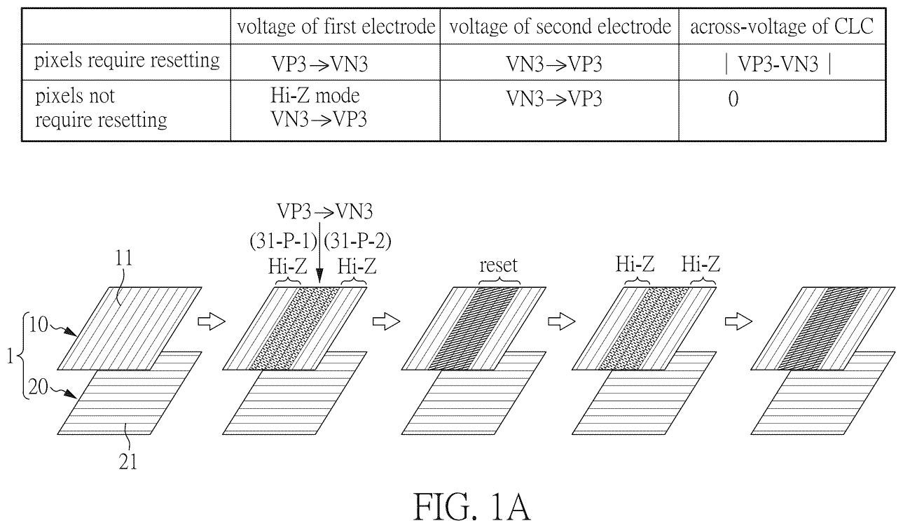

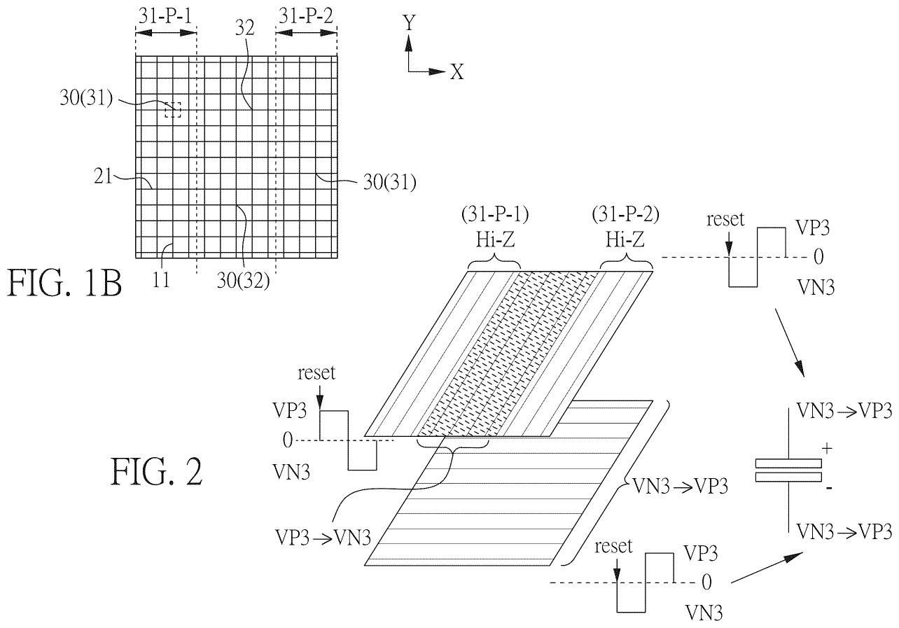

FIG. 1A shows a driving method for an electronic device according to an embodiment of the present disclosure, which is provided to perform a partial resetting on a panel 1. The panel 1 is a passive-matrix reflective panel, such as a cholesteric liquid crystal panel, an electronic ink liquid crystal panel, or other similar panels. For clarity, in the following description, a cholesteric liquid crystal panel is taken as an example, but it is not limited thereto. The panel 1 includes a first electrode layer 10, a second electrode layer 20, and a cholesteric liquid crystal (not shown) disposed between the first electrode layer 10 and the second electrode layer 20. FIG. 1B further shows a schematic structural diagram of the panel 1. The first electrode layer 10 of panel 1 includes a plurality of first electrodes 11 extending in the Y direction, and the second electrode layer 20 of panel 1 includes a plurality of second electrodes 21 extending in the X direction, wherein a pixel 30 is defined as the intersection of a first electrode 11 and a second electrode 21, and thus the panel 1 may include a plurality of pixels 30. The plurality of pixels 30 may be arranged, for example, in a matrix to be divided into a plurality of portions, thereby enabling a partial resetting to be performed on the panel 1, while it is not limited thereto. It should be noted that, although being shown only as lines in FIG. 1B, the first electrode 11 and the second electrode 21 actually have appropriate widths and, although being shown only as a dot in FIG. 1B, the pixel 30 actually has appropriate length and width.

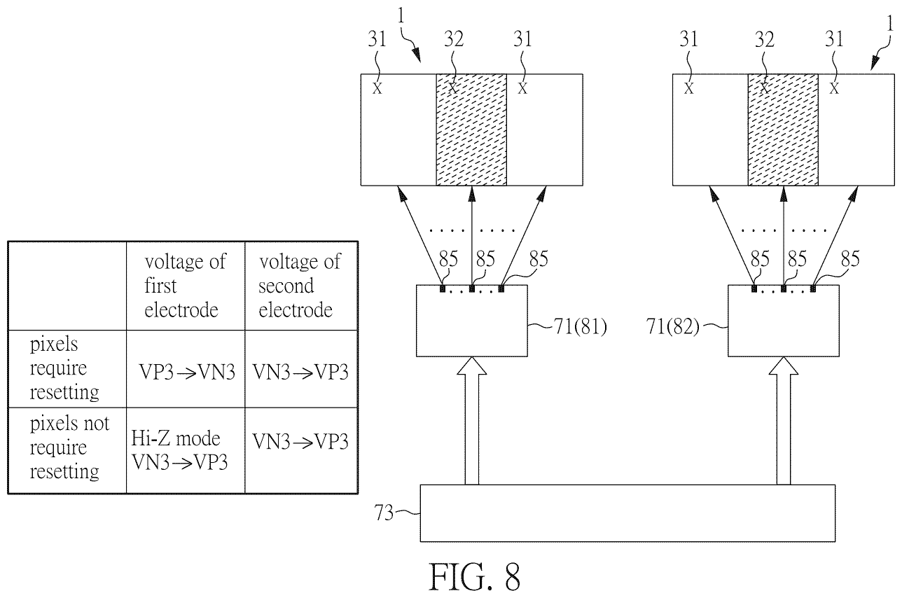

Referring again to FIG. 1A and FIG. 1B, when a partial resetting is to be performed on the panel 1, the plurality of pixels 30 may be divided into a plurality of pixels 31 that do not require resetting (for example, first pixels) and a plurality of pixels 32 that require resetting (for example, second pixels). The plurality of pixels 31 that do not require updating (for example, first pixels) are divided into a plurality of portions and are located on different sides of the plurality of pixels 32 that require resetting (for example, second pixels), or the plurality of pixels 32 that require resetting (for example, second pixels) are divided into a plurality of portions and are located on different sides of the plurality of pixels 31 that do not require resetting (for example, first pixels). In this embodiment, as shown in FIG. 1B, the plurality of pixels 31 that do not require resetting (for example, first pixels) are divided into two portions 31-P-1 and 31-P-2 and are located on different sides of the plurality of pixels 32 that require resetting (for example, second pixels), and the number of pixels in each of the two portions 31-P-1 and 31-P-2 may be the same or different. When a control element 73 (shown in FIG. 8) determines that the panel 1 is to be partially reset, during the reset phase of the panel 1, the control element 73 provides a first logic signal to first driving element 81 (shown in FIG. 8) for setting a plurality of first pixels electrically connected to first driving element 81 to a high-impedance (Hi-Z) mode, wherein these first pixels are pixels 31 in the panel 1 that do not require resetting. During the reset phase of the panel 1, according to the first logic signal, the first driving element 81 causes the voltage of first electrodes 11 of the first pixels (pixels 31 that do not require resetting) electrically connected thereto to be in floating state. During the reset phase of the panel 1, the control element 73 provides a second logic signal to first driving element 81, causing the voltage of the first electrodes 11 of second pixels electrically connected to first driving element 81 to present a first voltage waveform (for example, VP3→VN3), wherein the second pixels are pixels 32 in panel 1 that require resetting.

The driving method for an electronic device further provides a second driving element 82 (shown in FIG. 8), and the second driving element 82 is electrically connected between the panel 1 and the control element 73. In the reset phase of the panel 1, the control element 73 provides a third logic signal to the second driving element 82, so that the voltage of the second electrodes 21 of the plurality of second pixels (pixels 32 that require resetting) in the panel 1 electrically connected to the second driving element 82 and the voltage of the second electrodes 21 of the plurality of first pixels (pixels 31 that do not require resetting) present a second voltage waveform (for example, VN3→VP3) and a third voltage waveform (for example, VN3→VP3), respectively, and the third voltage waveform (for example, VN3→VP3) is the same as the second voltage waveform (for example, VN3→VP3), wherein the second electrodes 21 of the plurality of first pixels (pixels 31 that do not require resetting) overlap with the first electrodes 11 of the plurality of first pixels (as shown in FIG. 1B), and the second electrodes 21 of the plurality of second pixels (pixels 32 that require resetting) overlap with the first electrodes 11 of the plurality of second pixels (pixels 32 that require resetting) (as shown in FIG. 1B). In other words, when the driving method of the present disclosure is used to perform a partial resetting on the panel 1, for a plurality of pixels 32 that require resetting (for example, the second pixels), the voltage of the first electrodes 11 of the plurality of pixels 32 that require resetting (for example, the second pixels) may be controlled to present a first voltage waveform (for example, VP3→VN3), and the voltage of the second electrodes 21 of the plurality of pixels 32 that require resetting (for example, the second pixels) may be controlled to present a second voltage waveform (e.g., VN3→VP3). For a plurality of pixels 31 that do not require resetting (for example, the first pixels), a high-impedance (Hi-Z) mode may be set so that the first electrodes 11 thereof are, for example, in a high-impedance (Hi-Z) mode, and the voltage of the second electrodes 21 of the plurality of pixels 31 that do not require resetting (for example, the first pixels) is controlled to present a third voltage waveform (for example, VN3→VP3), wherein the third voltage waveform (VN3→VP3) may be, for example, the same as the second voltage waveform (for example, VN3→VP3). In other embodiments (not shown), the first voltage waveform and the second voltage waveform may be waveforms of opposite polarity, for example, the first voltage waveform may be, for example, VN3→VP3, and the second voltage waveform may be, for example, VP3→VN3. In this case, the third voltage waveform may be the same as the second voltage waveform, for example, VP3→VN3.

Next, referring to FIG. 2, which is a schematic diagram illustrating a partial resetting is performed on the panel 1, the first voltage waveform (VP3→VN3) is, for example, an AC voltage waveform that alternates between a positive voltage VP3 and a negative voltage VN3 at least once, and the second voltage waveform (VN3→VP3) is, for example, an AC voltage waveform that alternates between a negative voltage VN3 and a positive voltage VP3 at least once, wherein |VN3|is, for example, equal to |VP3|. Because the across-voltage of the cholesteric liquid crystal (CLC) between the first electrodes 11 and the second electrodes 21 of the plurality of pixels 32 that require resetting (for example, second pixels) is |VP3-VN3|, the plurality of pixels 32 that require resetting (for example, second pixels) may thus be reset. At the same time, in the Hi-Z mode, the first electrodes 11 of the plurality of pixels 31 that do not require resetting (for example, first pixels) are in a floating state. Due to the capacitive coupling effect, the voltage of the first electrodes 11 of the plurality of pixels 31 that do not require resetting (for example, first pixels) becomes close to the voltage of the second electrodes 21 of the plurality of pixels 31 that do not require resetting (for example, first pixels); for example, the difference between the voltage of the first electrodes 11 and the voltage of the second electrodes 21 of the plurality of pixels 31 that do not require resetting (for example, first pixels) is within 5%, while it is not limited thereto. Therefore, the cross-voltage of cholesteric liquid crystal between the first electrodes 11 and the second electrodes 21 of the plurality of pixels 31 that do not require resetting (for example, first pixels) is approximately 0. Therefore, the plurality of pixels 31 that do not require resetting (for example, first pixels) are not reset.

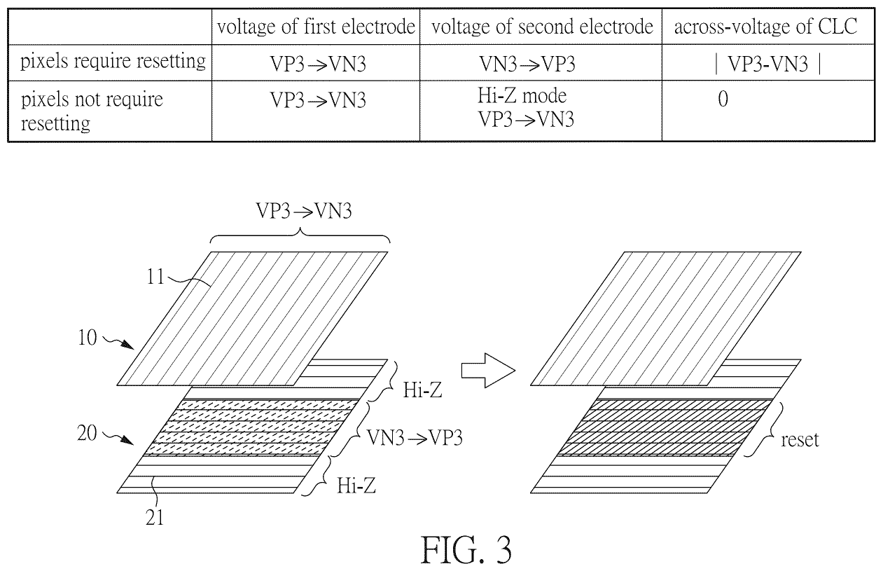

Please refer to FIG. 3, which shows a driving method for an electronic device for performing a partial resetting on a panel according to another embodiment of the present disclosure. This embodiment is similar to the embodiment of FIG. 1A, except that, when performing a partial resetting on the panel 1, for a plurality of pixels 32 that require resetting (for example, second pixels), the voltage of the second electrodes 21 of the plurality of pixels 32 that require resetting may be controlled to present a second voltage waveform (for example, VN3→VP3), and the voltage of the first electrodes 11 of the plurality of pixels 32 that require resetting (for example, second pixels) may be controlled to have a first voltage waveform (for example, VP3→VN3); for a plurality of pixels 31 that do not require resetting (for example, first pixels), the second electrodes 21 of the plurality of pixels 31 that do not require resetting (for example, the first pixels) may be set to a high impedance (Hi-Z) mode, and the voltage of the first electrodes 21 of the plurality of pixels 31 that do not require resetting (for example, first pixels) may be controlled to have a third voltage waveform (for example, VP3→VN3), which is the same as the first voltage waveform. Accordingly, since the cross-voltage of the cholesteric liquid crystal between the first electrodes 11 and the second electrodes 21 of the plurality of pixels 32 that require resetting (for example, second pixels) is |VP3-VN3|, the plurality of pixels 32 that require resetting (for example, second pixels) may be reset. At the same time, the voltage of the second electrodes 21 of the plurality of pixels 31 that do not required resetting (for example, first pixels) in the Hi-Z mode is in a floating state. Due to the capacitive coupling effect, the voltage of the second electrodes 21 of the plurality of pixels 31 that do not require resetting (for example, first pixels) becomes close to the same voltage as the first electrodes 11 of the plurality of pixels 31 that do not require resetting (for example, first pixels). Therefore, the cross-voltage of the cholesteric liquid crystal between the first electrodes 11 and the second electrodes 21 of the plurality of pixels 31 that do not require resetting (for example, first pixels) is approximately 0, so that the plurality of pixels 31 that do not require resetting (for example, first pixels) are not reset.

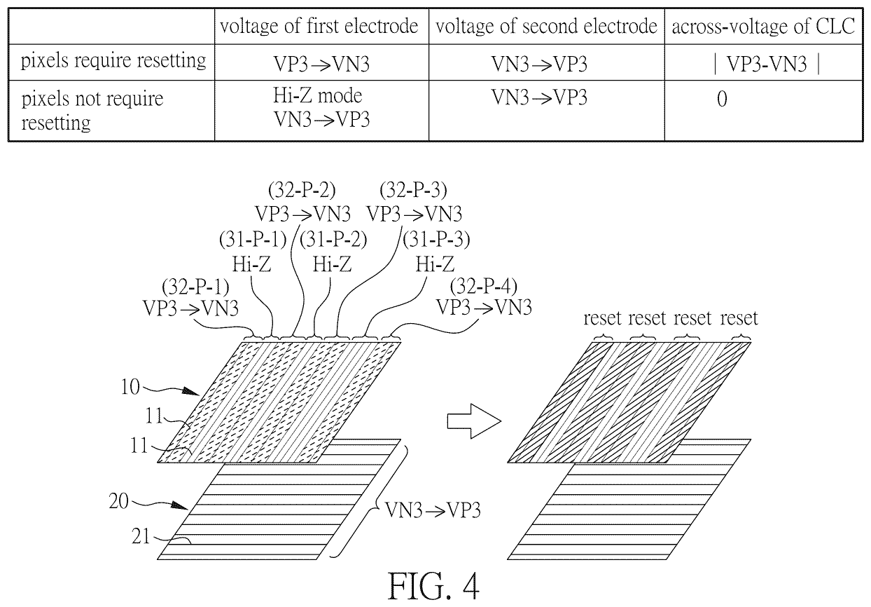

Please refer to FIG. 4, which shows a driving method for an electronic device for performing a partial resetting on a panel according to another embodiment of the present disclosure. This embodiment is similar to the embodiment of FIG. 1A, except that the plurality of pixels 31 that do not require resetting (for example, first pixels) are divided into a plurality of first portions, the plurality of pixels 32 that require resetting (for example, second pixels) are divided into a plurality of second portions, and the plurality of first portions and the plurality of second portions are arranged alternately. The number of pixels respectively included in the plurality of first portions and the plurality of second portions may be the same or different, the number of pixels respectively included in different first portions may be the same or different, and the number of pixels respectively included in different second portions may be the same or different. In this embodiment, as shown in FIG. 4, the plurality of pixels 31 that do not require resetting (for example, first pixels) are divided into three first portions 31-P-1~31-P-3, and the plurality of pixels 32 that require resetting (for example, second pixels) are divided into four second portions 32-P-1~32-P-4. The second portions 32-P-1 and 32-P-2 are respectively located on different sides of the first portion 31-P-1, the second portions 32-P-2 and 32-P-3 are respectively located on different sides of the first portion 31-P-2, and the second portions 32-P-3 and 32-P-4 are respectively located on different sides of the first portion 31-P-3. The number of the aforementioned first portions and second portions is only for illustrative purpose and may be modified according to the needs. Accordingly, when performing a partial resetting on the panel using the driving method of the present disclosure, for the pixels 32 that require resetting (for example, second pixels), the first electrodes 11 of the plurality of pixels 32 that require resetting (for example, second pixels) may be controlled to present a first voltage waveform (for example, VP3→VN3), and the second electrodes 21 of the plurality of pixels 32 that require resetting (for example, second pixels) may be controlled to present a second voltage waveform (for example, VN3→VP3). For the pixels 31 that do not require resetting (for example, first pixels), the first electrodes 11 of the plurality of pixels 31 that do not require resetting (for example, first pixels) may be set to a high impedance (Hi-Z) mode, and the voltage of the second electrodes 21 of the plurality of pixels 31 that do not require resetting (for example, first pixels) may be controlled to present a second voltage waveform (for example, VN3→VP3). Since the cross-voltage of the cholesteric liquid crystal between the first electrodes 11 and the second electrodes 21 of the plurality of pixels 32 that require resetting (for example, second pixels) is |VP3-VN3|, the plurality of pixels 32 that require resetting (for example, second pixels) may thus be reset. At the same time, the voltage of the first electrodes 11 of the plurality of pixels 31 that do not require resetting (for example, first pixels) in the Hi-Z mode is in a floating state. Due to the capacitive coupling effect, the voltage of the first electrodes 11 of the plurality of pixels 31 that do not require resetting (for example, first pixels) becomes close to the voltage of the second electrodes 21 of the plurality of pixels 31 that do not require resetting (for example, first pixels). Therefore, the cross-voltage of the cholesteric liquid crystal between the first electrodes 11 and the second electrodes 21 of the plurality of pixels 31 that do not require resetting (for example, first pixels) is approximately 0, so that the plurality of pixels 31 that do not require resetting (for example, first pixels) are not reset. In other embodiments (not shown), the first voltage waveform and the second voltage waveform have opposite polarities; that is, the first voltage waveform is, for example, VN3→VP3, and the second voltage waveform is, for example, VP3→VN3.

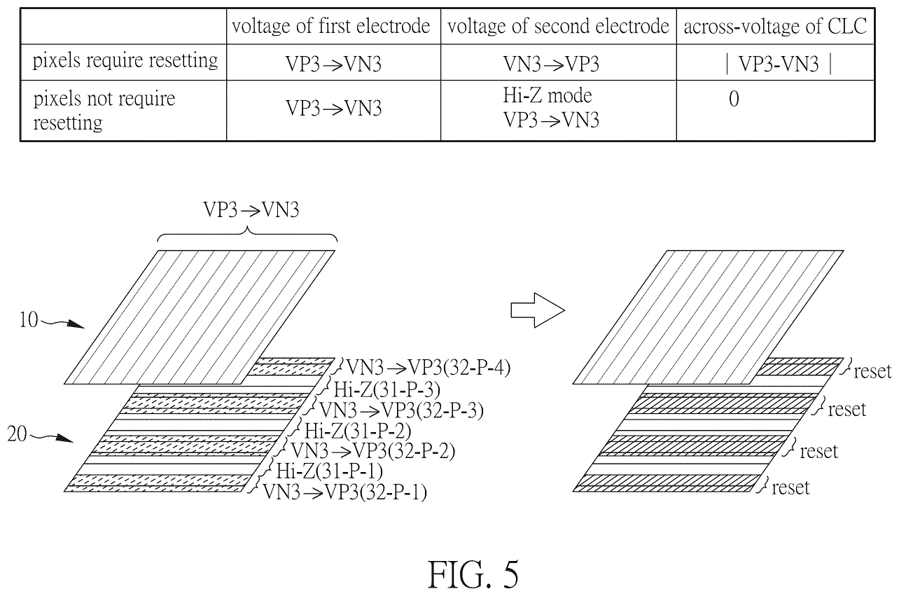

Please refer to FIG. 5, which shows a driving method for an electronic device for performing a partial resetting on a panel according to another embodiment of the present disclosure. This embodiment is similar to the embodiment of FIG. 3, except that the plurality of pixels 31 that do not require resetting (for example, first pixels) are divided into a plurality of first portions, the plurality of pixels 32 that require resetting (for example, second pixels) are divided into a plurality of second portions, and the plurality of first portions and the plurality of second portions are arranged alternately. The number of pixels respectively included in the plurality of first portions and the plurality of second portions may be the same or different, the number of pixels respectively included in different first portions may be the same or different, and the number of pixels respectively included in different second portions may be the same or different. In this embodiment, as shown in FIG. 5, the plurality of pixels 31 that do not require resetting (for example, first pixels) are divided into three first portions 31-P-1~31-P-3, and the plurality of pixels 32 that require resetting (for example, second pixels) are divided into four second portions 32-P-1~32-P-4. The second portions 32-P-1 and 32-P-2 are respectively located on different sides of the first portion 31-P-1, the second portions 32-P-2 and 32-P-3 are respectively located on different sides of the first portion 31-P-2, and the second portions 32-P-3 and 32-P-4 are respectively located on different sides of the first portion 31-P-3. The number of the aforementioned first portions and second portions is only for illustrative purpose and may be modified according to the needs. Accordingly, when performing a partial resetting on the panel using the driving method of the present disclosure, for a plurality of pixels 32 that require resetting (for example, second pixels), the voltage of the second electrodes 21 of the plurality of pixels 32 that require resetting (for example, second pixels) may be controlled to present a second voltage waveform (for example, VN3→VP3), and the voltage of the first electrodes 11 of the plurality of pixels 32 that require resetting (for example, second pixels) may be controlled to present a first voltage waveform (for example, VP3→VN3). For a plurality of pixels 31 that do not require resetting (for example, first pixels), the second electrodes 21 of the plurality of pixels 31 that do not require resetting (for example, first pixels) may be set to a high impedance (Hi-Z) mode, and the voltage of the first electrodes 11 of the plurality of pixels 31 that do not require resetting (for example, first pixels) may be controlled to present a first voltage waveform (for example, VP3→VN3). Since the cross-voltage of the cholesteric liquid crystal between the first electrodes 11 and the second electrodes 21 of the plurality of pixels 32 that require resetting (for example, second pixels) is |VP3-VN3|, the plurality of pixels 32 that require resetting (for example, second pixels) may be reset. At the same time, the voltage of the second electrodes 21 of the plurality of pixels 31 that do not require resetting (for example, first pixels) in the Hi-Z mode is in a floating state. Due to the capacitive coupling effect, the voltage of the second electrodes 21 of the plurality of pixels 31 that do not require resetting (for example, first pixels) becomes close to the voltage of the first electrodes 11 of the plurality of pixels 31 that do not require resetting (for example, first pixels). Therefore, the cross-voltage of the cholesteric liquid crystal between the first electrodes 11 and the second electrodes 21 of the plurality of pixels 31 that do not require resetting (for example, first pixels) is approximately 0, so that the plurality of pixels 31 that do not require resetting are not reset.

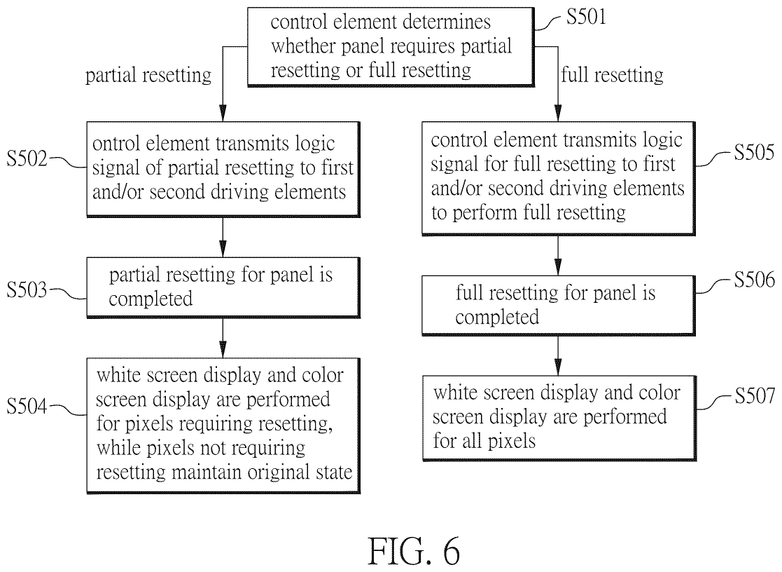

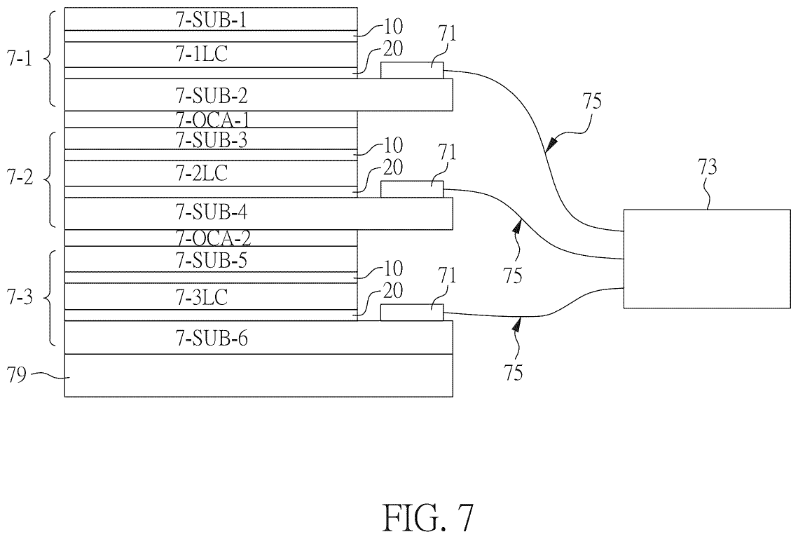

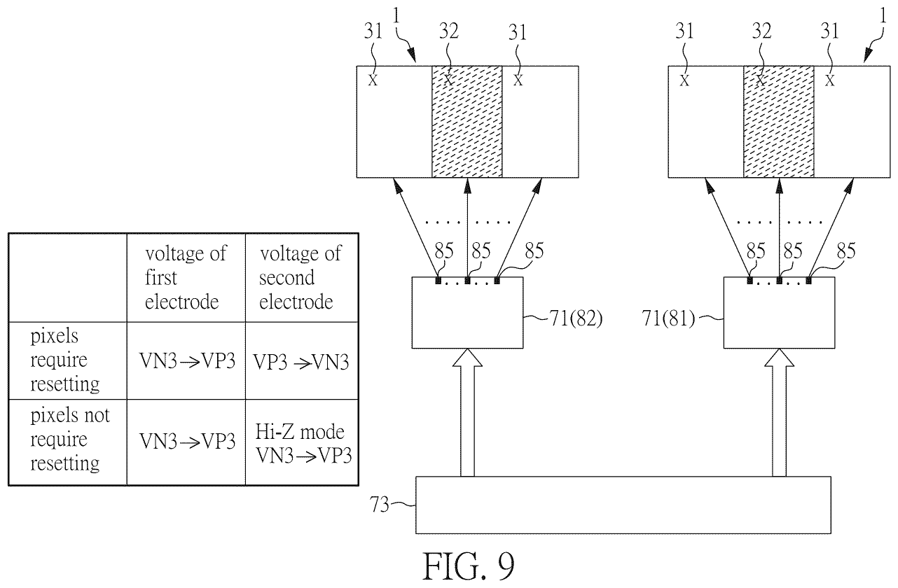

FIG. 6 is a flowchart illustrating a driving method for an electronic device of the present disclosure, FIG. 7 is a cross-sectional structural diagram of an electronic device of the present disclosure, FIG. 8 is a circuit block diagram of an electronic device of the present disclosure for performing the driving method of the embodiment shown in FIG. 1A or FIG. 4, and FIG. 9 is another circuit block diagram of an electronic device of the present disclosure for performing the driving method of the embodiment shown in FIG. 3 or FIG. 5. As shown in FIG. 7, a panel (for example, reflective panel) 1 of the electronic device includes a plurality of sub-panels and optical adhesives. The plurality of sub-panels are used to reflect light of different colors, respectively. For example, the panel includes a sub-panel 7-1 (for example, a cholesteric liquid crystal panel that reflects blue light in a planar state), a first optical adhesive 7-OCA-1, a sub-panel 7-2 (for example, a cholesteric liquid crystal panel that reflects green light in a planar state), a second optical adhesive 7-OCA-2, a sub-panel 7-3 (for example, a cholesteric liquid crystal panel that reflects red light in a planar state), and a black absorption layer 79 arranged from top to bottom, while it is not limited thereto. The sub-panel 7-1 includes a substrate 7-SUB-1, a first electrode layer 10, a cholesteric liquid crystal layer 7-1LC (for example, a cholesteric liquid crystal layer that reflects blue light), a second electrode layer 20, and a substrate 7-SUB-2. The sub-panel 7-2 includes a substrate 7-SUB-3, a first electrode layer 10, a cholesteric liquid crystal layer 7-2LC (for example, a cholesteric liquid crystal layer that reflects green light), a second electrode layer 20, and a substrate 7-SUB-4. The sub-panel 7-3 includes a substrate 7-SUB-5, a first electrode layer 10, a cholesteric liquid crystal layer 7-3LC (for example, a cholesteric liquid crystal layer that reflects red light), a second electrode layer 20, and a substrate 7-SUB-6 arranged from top to bottom. The substrate 7-SUB-2 of the sub-panel 7-1, the substrate 7-SUB-4 of the sub-panel 7-2, and the substrate 7-SUB-6 of the sub-panel 7-3 are each provided with a driving element 71. The driving elements 71 are each electrically connected to the control element 73 through a circuit board (for example, flexible circuit board) 75, so that the control element 73 controls the driving elements 71 to drive the electronic device to perform a screen display, a partial resetting, etc. In other embodiments (not shown), the panel 1 may include other numbers of sub-panels, and the order of the colors of the light reflected by the cholesteric liquid crystals in the sub-panels in the planar state is not limited to the above, and may be adjusted according to the needs.

Next, the flowchart of the driving method of FIG. 6 is described. First, in step S501, the control element (for example, TCON) 73 determines whether the panel 1 requires a partial resetting or a full resetting. When the control element 73 determines that a partial resetting is required, the control element 73 transmits a logic signal of the partial resetting to the driving elements 71 (step S502). If a partial resetting in the embodiment of FIG. 1A or FIG. 4 is performed, with reference to the circuit block diagram of the electronic device of the present disclosure shown in FIG. 8, the pixels to be reset or not reset in the panel 1 include, for example, pixels of the sub-panel 7-1, sub-panel 7-2, and/or sub-panel 7-3. The circuit for control and driving includes the driving element 71 and the control element 73. The driving element 71 includes a first driving element 81 and a second driving element 82. The first driving element 81 is electrically connected between the panel 1 and the control element 73, and the second driving element 82 is electrically connected between the panel 1 and the control element 73. Accordingly, when performing a partial resetting on the panel 1, in the reset phase of the panel 1, the control element 73 provides a first logic signal to the first driving element 81, so that a plurality of first pixels electrically connected to the first driving element 81 (pixels 31 in the panel 7-1, sub-panel 7-2 and/or sub-panel 7-3 that do not require resetting) are set to a high impedance mode, and the driving signal is transmitted to the plurality of pixels 31 that do not require resetting (for example, first pixels) in the panel 1 (for example, including the sub-panel 7-1, sub-panel 7-2 and/or sub-panel 7-3) via the conductive pads 85 of the first driving element 81, so that the voltage of the first electrodes 11 in the plurality of pixels 31 that do not require resetting (for example, first pixels) in a floating state. In a reset phase of the panel, the control element 73 provides a second logic signal to the first driving element 81, so that the voltage of the first electrodes of a plurality of pixels 32 that require resetting (for example, second pixels) in the panel 1 electrically connected to the first driving element 81 presents a first voltage waveform (for example, VP3→VN3, but not limited thereto). Furthermore, in the reset phase of the panel 1, the control element 73 provides a third logic signal to the second driving element 82, so that the voltage of the second electrodes 21 of a plurality of pixels 32 that require resetting (for example, second pixels) and the voltage of the second electrodes 21 of a plurality of pixels 31 that do not require resetting (for example, first pixels) in the panel 1 electrically connected to the second driving element 82 present a second voltage waveform (for example, VN3→VP3) and a third voltage waveform (for example, VN3→VP3), respectively, thereby performing a partial resetting.

In addition, in step S502, when performing a partial resetting in the embodiment of FIG. 3 or FIG. 5, with reference to a circuit block diagram of the electronic device of the present disclosure shown in FIG. 9, the pixels to be reset or not reset in the panel include, for example, pixels of sub-panel 7-1, sub-panel 7-2, and/or sub-panel 7-3. The circuit for control and driving includes the driving element 71 and the control element 73. The driving element 71 includes a first driving element 81 and a second driving element 82. The first driving element 81 is electrically connected between the panel 1 and the control element 73, and the second driving element 82 is electrically connected between the panel 1 and the control element 73. Accordingly, when performing a partial resetting on the panel 1, in the reset phase of the panel 1, the control element 73 provides a first logic signal (Hi-Z) to the second driving element 82, so that a plurality of first pixels electrically connected to the second driving element 82 (pixels 31 that do not require resetting in the sub-panel 7-1, sub-panel 7-2 and/or sub-panel 7-3) are set to a high impedance mode, and the driving signal is transmitted to the plurality of pixels 31 that do not require resetting (for example, first pixels) in the panel 1 (for example, including the sub-panel 7-1, sub-panel 7-2 and/or sub-panel 7-3) via the conductive pads 85 of the second driving element 82, so that the voltage of the second electrodes 21 in the plurality of pixels 31 that do not require resetting (for example, first pixels) in a floating state. In the reset phase of the panel, the control element 73 provides a second logic signal to the second driving element 82, so that the voltage of the second electrodes 21 of the plurality of pixels 32 that require resetting (for example, second pixels) in the panel 1 electrically connected to the second driving element 82 presents a first voltage waveform (for example, VP3→VN3). In the reset phase of the panel, the control element 73 provides a third logic signal to the first driving element 81, so that the voltage of the first electrode 11 of a plurality of pixels 31 that do not require resetting (for example, first pixels) and the voltage of the first electrodes 11 of a plurality of pixels 32 that require resetting (for example, second pixels) in the panel 1 electrically connected to the first driving element 81 present a second voltage waveform (for example, VN3→VP3) and a third voltage waveform (for example, VN3→VP3), respectively, thereby performing a partial resetting.

After the aforementioned step S502, it is able to complete the partial resetting for the pixels in the sub-panel 7-1, sub-panel 7-2 and/or sub-panel 7-3 of the panel 1 (step S503). Therefore, white screen display (Interval) and color screen display (Addressing) may be performed for the pixels 32 that require resetting (for example, second pixels), while the pixels 31 that do not require resetting (for example, first pixels) maintain the original state (step S504).

If the control element 73 determines, in step S501, that a full resetting is required, the control element 73 transmits a logic signal for a full resetting to the driving element 71 (step S505). If a full resetting in the embodiment of FIG. 1A or FIG. 4 is performed, with reference to FIG. 8, in the reset phase of the panel 1, the control element 73 provides a second logic signal to the first driving element 81 so that the voltage of the first electrodes 11 of all pixels 31 and 32 in the panel 1 electrically connected to the first driving element 81 presents a first voltage waveform (for example, VP3→VN3), and the control element 73 also provides a third logic signal (for example, VN3→VP3) to the second driving element 82 so that the voltage of the second electrodes 21 of all pixels 31 and 32 in the panel 1 electrically connected to the second driving element 82 presents a second voltage waveform (for example, VN3→VP3), wherein the first voltage waveform (for example, VP3→VN3) is different from the second voltage waveform (for example, VN3→VP3), thereby performing a full resetting. Furthermore, in step S505, if a full resetting in the embodiment of FIG. 3 or FIG. 5 is performed, with reference to FIG. 9, in the reset phase of the panel 1, the control element 73 provides a second logic signal to the second driving element 82 so that the voltage of the second electrodes 21 of all pixels 31 and 32 in the panel 1 electrically connected to the second driving element 82 presents a first voltage waveform (VP3→VN3), and the control element provides a third logic signal to the first driving element 81 so that the voltage of the first electrodes 11 of all pixels 31 and 32 in the panel 1 electrically connected to the second driving element 82 presents a second voltage waveform (VN3→VP3), thereby performing a full resetting.

After step S505, it is able to complete the full resetting for the pixels in sub-panel 7-1, sub-panel 7-2 and/or sub-panel 7-3 of panel 1 (step S506). Therefore, white screen display (Interval) and color screen display (Addressing) may be performed for all the pixels (step S507).

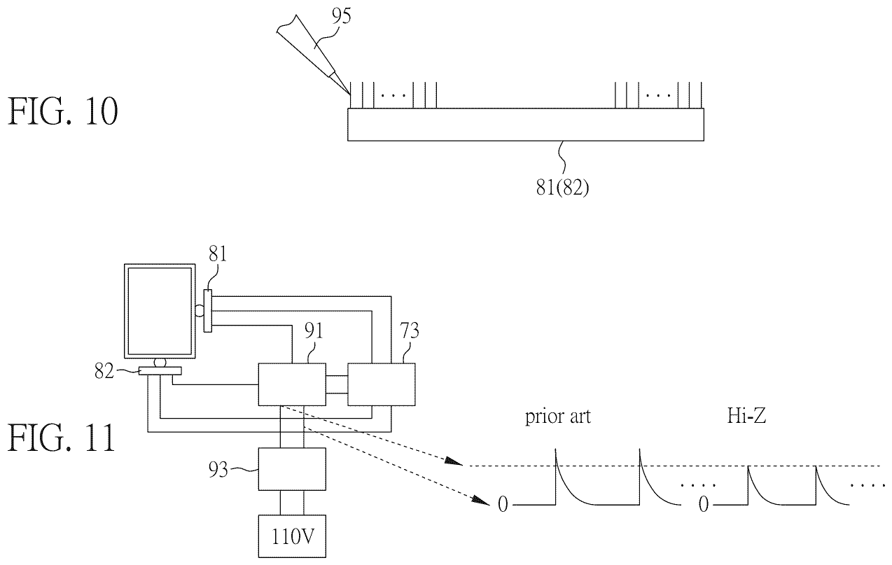

FIG. 10 shows an embodiment for demonstrating the use of the driving method for an electronic device of the present disclosure for performing a partial resetting on a panel. As shown, the output voltage of the first driving element 81 and/or the second driving element 82 is measured using a carbon rod 95 (or a similar element) of an oscilloscope when the electronic device is operating. When the electronic device operates using a conventional driving method, the driving element will output a fixed voltage so that the measured voltage will not be lost. Therefore, if the measured voltage has an output level, it can be known that the conventional driving method is being used. When the electronic device operates using the driving method of the present disclosure, in the Hi-Z mode, even the voltage generated by capacitive coupling will be lost within a short period of time (several milliseconds). Therefore, if the voltage measured by the oscilloscope is found to be lost over time, it can be known that the driving method of the present disclosure is being used.

FIG. 11 shows another embodiment for demonstrating the use of the driving method for an electronic device of the present disclosure for performing a partial resetting on a panel. As shown, a transformer 93 is used to transmit voltage to a power board 91, so that the power board 91 may switch the mode (Hi-Z mode or normal mode in the prior art) according to the control of the control element 73. Then, the current at the position where the transformer 93 supplies power to the power board 91 is measured. As shown in FIG. 11, the peak value of the instantaneous current in the normal mode is slightly higher than the instantaneous current in the Hi-Z mode used in the present disclosure. Based on this, it can be determined whether the driving method for an electronic device of the present disclosure is used for performing a partial resetting on a panel or not.

As can be seen from the above description, the present disclosure applies a voltage to a middle portion of the first electrodes while setting the remaining two side portions of first electrodes in a Hi-Z mode, rather than applying the same voltage as the second electrodes, and simultaneously applies another voltage to all the second electrodes, which creates a capacitor-like characteristic between the first and second electrodes. As a result, the first electrodes in the Hi-Z mode are at the same voltage as the second electrodes due to the capacitor-like characteristic. Therefore, the cholesteric liquid crystal in the middle portion may obtain a voltage difference sufficient to transition to a homeotropic state, causing the cholesteric liquid crystal in the middle portion to refresh and achieve the effect of screen resetting. Compared to the techniques in prior art, the present disclosure applies a Hi-Z mode to the first electrodes (second electrodes) rather than applying a single voltage as in the prior partial resetting modes, thereby effectively reducing the power consumption of the cholesteric liquid crystal.

The features among various embodiments of the present disclosure may be mixed and matched arbitrarily as long as they do not violate the spirit of the disclosure or conflict with each other.

The aforementioned specific embodiments should be construed as merely illustrative, and not limiting the rest of the present disclosure in any way.

1. A driving method for an electronic device, comprising:
providing a panel, a first driving element, and a control element, wherein the first driving element is electrically connected between the panel and the control element;
when the control element determines that the panel requires a partial resetting, in a reset phase of the panel, the control element providing a first logic signal to the first driving element, so that a plurality of first pixels electrically connected to the first driving element are set to a high-impedance mode, wherein the plurality of first pixels are pixels in the panel that do not require resetting.

2. The driving method for an electronic device as claimed in claim 1, wherein, in the reset phase of the panel, according to the first logic signal, the first driving element causes a voltage of first electrodes of the plurality of first pixels electrically connected to the first driving element is in a floating state.

3. The driving method for an electronic device as claimed in claim 1, wherein, in the reset phase of the panel, the control element provides a second logic signal to the first driving element so that a voltage of first electrodes of a plurality of second pixels electrically connected to the first driving element presents a first voltage waveform, wherein the plurality of second pixels are pixels in the panel that require resetting.

4. The driving method for an electronic device as claimed in claim 3, further comprising a second driving element electrically connected between the panel and the control element, wherein, in the reset phase of the panel, the control element provides a third logic signal to the second driving element so that a voltage of second electrodes of the plurality of second pixels and a voltage of the second electrodes of the plurality of first pixels in the panel electrically connected to the second driving element present a second voltage waveform and a third voltage waveform, respectively, wherein the third voltage waveform is as same as the second voltage waveform, the second electrodes of the plurality of first pixels overlap with the first electrodes of the plurality of first pixels, and the second electrodes of the plurality of second pixels overlap with the first electrodes of the plurality of second pixels.

5. The driving method for an electronic device as claimed in claim 4, wherein the first voltage waveform is different from the second voltage waveform.

6. The driving method for an electronic device as claimed in claim 3, wherein the plurality of first pixels are divided into a plurality of portions respectively located on different sides of the plurality of second pixels.

7. The driving method for an electronic device as claimed in claim 3, wherein the plurality of second pixels are divided into a plurality of portions respectively located on different sides of the plurality of first pixels.

8. The driving method for an electronic device as claimed in claim 3, wherein the plurality of first pixels are divided into a plurality of first portions, the plurality of second pixels are divided into a plurality of second portions, and the plurality of first portions and the plurality of second portions are arranged alternately.

9. The driving method for an electronic device as claimed in claim 1, wherein the panel is a reflective panel.

10. The driving method for an electronic device as claimed in claim 9, wherein the reflective panel includes a plurality of sub-panels, each reflecting light of a different color.

11. The driving method for an electronic device as claimed in claim 5, wherein the first voltage waveform and the second voltage waveform are waveforms of opposite polarity.

12. The driving method for an electronic device as claimed in claim 11, wherein the first voltage waveform is an AC voltage waveform that alternates between a positive voltage and a negative voltage at least once, the second voltage waveform is an AC voltage waveform that alternates between a negative voltage and a positive voltage at least once, and the third voltage waveform is an AC voltage waveform that alternates between a negative voltage and a positive voltage at least once.

13. The driving method for an electronic device as claimed in claim 11, wherein the first voltage waveform is an AC voltage waveform that alternates between a positive voltage and a negative voltage at least once, the second voltage waveform is an AC voltage waveform that alternates between a negative voltage and a positive voltage at least once, and the third voltage waveform is an AC voltage waveform that alternates between a positive voltage and a negative voltage at least once.

14. The driving method for an electronic device as claimed in claim 13, wherein an absolute value of the negative voltage is equal to an absolute value of the positive voltage.

15. The driving method for an electronic device as claimed in claim 10, wherein the plurality of sub-panels are respectively configured to reflect blue light, green light, and red light.

16. The driving method for an electronic device as claimed in claim 15, wherein the plurality of sub-panels include a cholesteric liquid crystal panel that reflects blue light in a planar state, a cholesteric liquid crystal panel that reflects green light in a planar state, and a cholesteric liquid crystal panel that reflects red light in a planar state.

17. The driving method for an electronic device as claimed in claim 15, further comprising a first optical adhesive disposed between the cholesteric liquid crystal panel that reflects blue light and the cholesteric liquid crystal panel that reflects green light, and a second optical adhesive disposed between the cholesteric liquid crystal panel that reflects green light and the cholesteric liquid crystal panel that reflects red light.

18. The driving method for an electronic device as claimed in claim 4, wherein, when the control element determines that the panel requires a full resetting, in a reset phase of the panel, the control element provides a second logic signal to the first driving element so that a voltage of the first electrodes of all pixels in the panel electrically connected to the first driving element presets a first voltage waveform, and the control element provides a third logic signal to the second driving element, so that the voltage of the second electrodes of all pixels in the panel electrically connected to the second driving element to present a second voltage waveform, where the first voltage waveform is different from the second voltage waveform.

19. The driving method for an electronic device as claimed in claim 18, wherein
the first voltage waveform is an AC voltage waveform that alternates between a positive voltage and a negative voltage at least once, and the second voltage waveform is an AC voltage waveform that alternates between a negative voltage and a positive voltage at least once.)

20. The driving method for an electronic device as claimed in claim 19, wherein an absolute value of the negative voltage is equal to an absolute value of the positive voltage.
